(19) United States
(12) Patent Application Publication
(10) Pub. No.: US 2025/0017805 A1
(43) Pub. Date: Jan. 16, 2025

(54) JOINT MANIPULATION DEVICE AND METHOD

(71) Applicant: Movement Medical LLC, Austin, TX (US)

(72) Inventors: Thomas J. Cunningham, Smyrna, GA (US); Timothy L. Lester, Smyrna, GA (US)

(73) Assignee: Movement Medical LLC, Austin, TX (US)

(21) Appl. No.: 18/771,286

(22) Filed: Jul. 12, 2024

Related U.S. Application Data
(60) Provisional application No. 63/513,569, filed on Jul. 14, 2023.

(51) Int. Cl. A61H 1/02

(52) U.S. Cl. CPC A61H 1/024; A61H 2201/0149; A61H 2201/0192; A61H 2201/123; A61H 2201/164

(57) ABSTRACT

A device for manipulating a joint of a limb of a user, including a linear actuator composed of at least two segments; one or more first rod segments is positioned relative to the user, supported by a wheel assembly having one or more wheels, such that the first rod segments is movable relative to a support surface, including a floor; one or more second rod segments is located relative to the user and is secured, such as a chair, such that the position of the second rod segments are secure; and a limb support mechanism is attached to the first rod segments such that when the first rod segments of the linear actuator moves, the limb support mechanism moves in a substantially parallel path as the actuator, and the limb of the user is manipulated. A footplate adjustor, wherein the footplate adjustor adjusts an angle of a foot plate.

### CROSS-REFERENCE TO RELATED APPLICATION

This application claims priority to, and the benefit of, U.S. Provisional Application No. 63/513,569, filed Jul. 14, 2023, all of which is hereby incorporated by reference in their entirety.

### BACKGROUND

The present disclosure generally relates to a joint manipulation device and method of use, and to a joint manipulation device for manipulation of a knee joint or other joints.

### SUMMARY

A device for manipulating a joint of a limb of a user, including a linear actuator composed of at least two segments; one or more first rod segments is positioned relative to the user, supported by a wheel assembly having one or more wheels, such that the first rod segments is movable relative to a support surface, including a floor; one or more second rod segments is located relative to the user and is secured to a stabilized object, such as a chair, such that the position of the second rod segments are secure; and a limb support mechanism is attached to the first rod segments such that when the first rod segments of the linear actuator moves, the limb support mechanism moves in a substantially parallel path as the actuator, and the limb of the user is manipulated.

The device may include the limb support mechanism is one of a foot mount, a limb strap, or a limb support. The device may further include a second linear actuator positioned or attached to the device to manipulate or position a second joint. The device may further include the limb support mechanism is a foot plate for supporting the foot of a user, and the limb of the user being manipulated is one of the legs including a knee joint.

The device may further include the movement of the device by an electromechanical means. The device may further include a frame assembly including one or more linear actuators, wherein the frame assembly is positioned at an incline from the support surface. A footplate adjustor, wherein the footplate adjustor adjusts the angle of the foot plate.

The device may further include a leg assembly is operatively attached to the second rod segments to support the device in the use position and/or a footplate adjustor, which is selectively positioned to lock at a predetermined angle. The device may further include the first rod segments are an outer housing of a rod cylinder and the second rod segments are the inner rod of a rod cylinder.

### BRIEF DESCRIPTION OF DRAWINGS

The description herein makes reference to the accompanying drawings wherein like reference numerals refer to like parts throughout the several views, wherein in the illustrative examples, the reference numerals correspond to the following elements. The drawings are illustrative and descriptive of the invention, but do not represent the entirety of the invention. Any elements in one figure may be swapped for another figure, without limitation.

FIG. 1 is an isometric view of a joint manipulation device;

FIG. 2 is another isometric view of a joint manipulation device;

FIG. 3 is a side view of a joint manipulation device, showing a floor or other contact surface;

FIG. 4 is an opposite side view of a joint manipulation device;

FIG. 5 is a bottom view of a joint manipulation device;

FIG. 6 is a top view of a joint manipulation device;

FIG. 7 is a front view of a joint manipulation device; and

FIG. 8 is a back view of a joint manipulation device.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

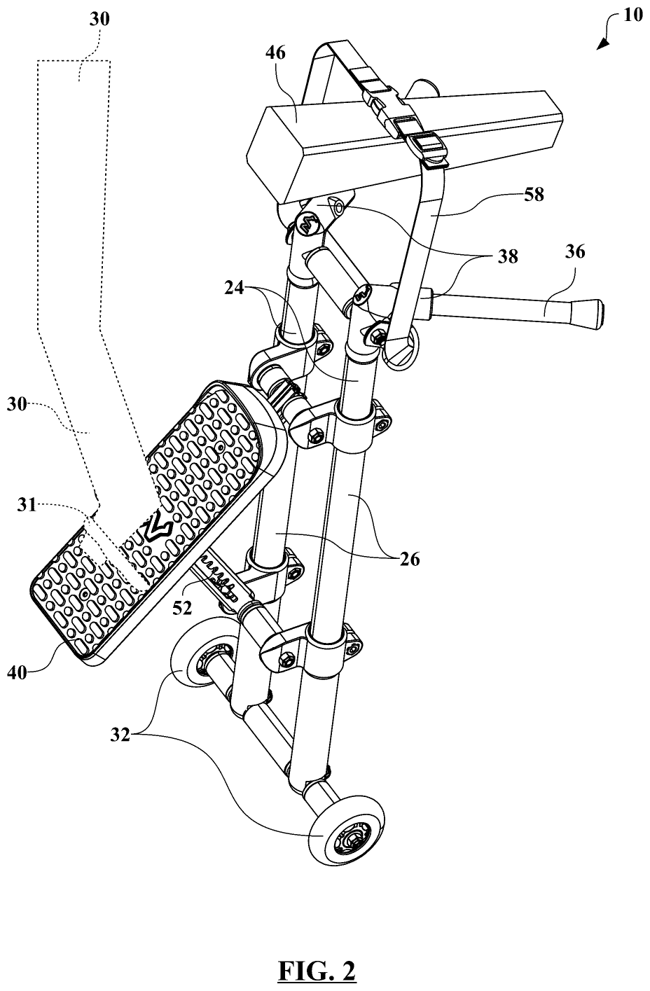

A joint manipulation device 10 (or device 10) is shown throughout the figures—note that several different joints, including, without limitation, knee or other joints—the leg and knee are shown, highly schematically in FIG. 2 as leg/knee 30, note that a user is attached to the leg/knee 30. A limb strap 31 is shown highly schematically in FIG. 2 and may alternatively be referred to as limb support and/or mechanism. Note that a second joint may be included, including, without limitation, an ankle joint.

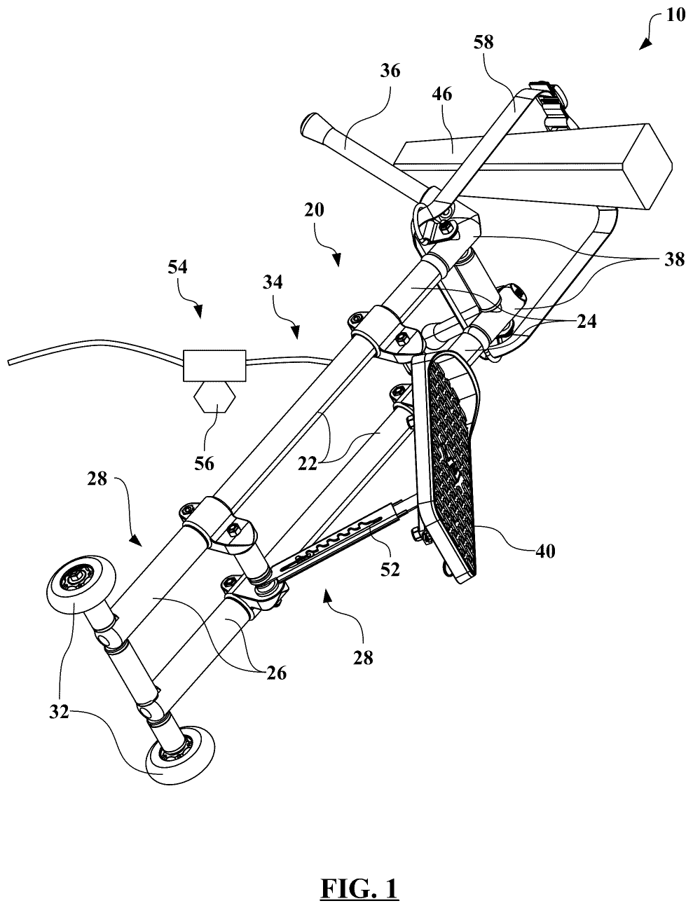

A power supply 54, with a cord, and a controller 56 are shown highly schematically in FIG. 1. Note that the controller 56 may be a wireless remote control or a wired remote control, and/or other elements recognizable to those having ordinary skill in the art. A frame assembly 20, which includes, without limitation, one or more extension rods 22 are shown throughout the figures. A first rod segment 24, which may move, and a second rod segment 26, which may be fixed, is also shown throughout the figures. The extension rods 22, the first rod segments 24, and the second rod segments 28 may include inner rods and outer rods.

There may be one or more linear actuators 28 or, simply, linear actuator 28, may be used. Note that the linear actuators 28 may be electromechanical in nature, or other types recognizable to those having ordinary skill in the art. These may be within frame assembly 20 or within the extension rods 22 and/or the within the first rod segments 24 and/or the second rod segments 26. One or more wheels 32 may also be located at, generally, one end of the device 10—note that the wheels 32 may be on both ends of the device 10.

The device 10 may include a leg assembly 34, which may have one or more legs 36. Note that the user and a chair may be located near device 10—the chair is not illustrated in the figures, but will be recognizable to those having ordinary skill in the art. The linear actuators 28 may be within any of the other structures of the device 10.

Furthermore, the drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

The following detailed description is merely illustrative in nature and is not intended to limit the application and uses. Furthermore, there is no intention to be bound by any expressed or implied theory presented herein. Throughout the drawings, corresponding reference numerals indicate like or corresponding parts and features.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements.

Many alternative or additional functional relationships or physical connections may be present in an embodiment. The use of ordinals such as first, second, and third does not necessarily imply a ranked sense of order, but rather may distinguish between multiple instances of an act or structure.

All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are, hereby, all disclosed as separate embodiment.

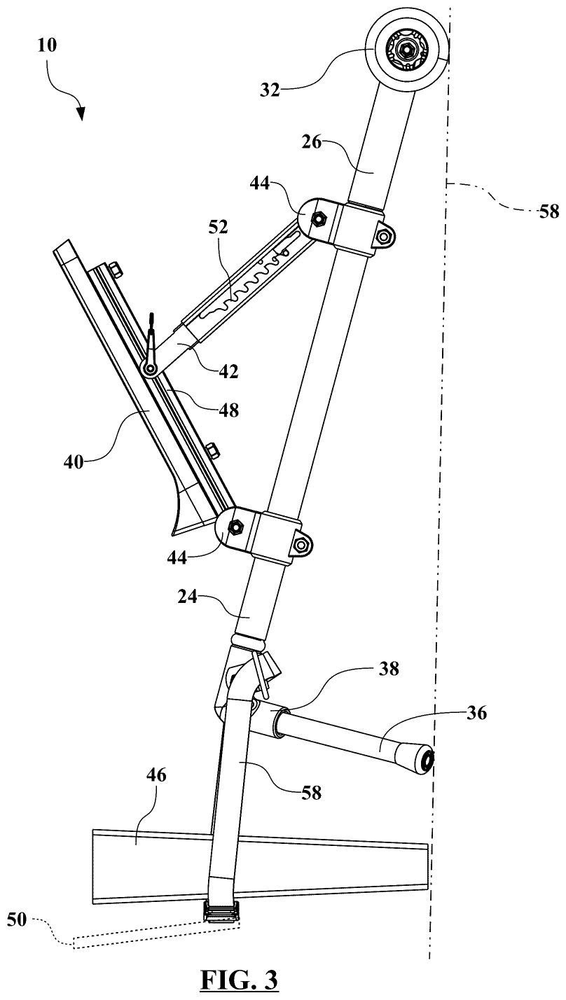

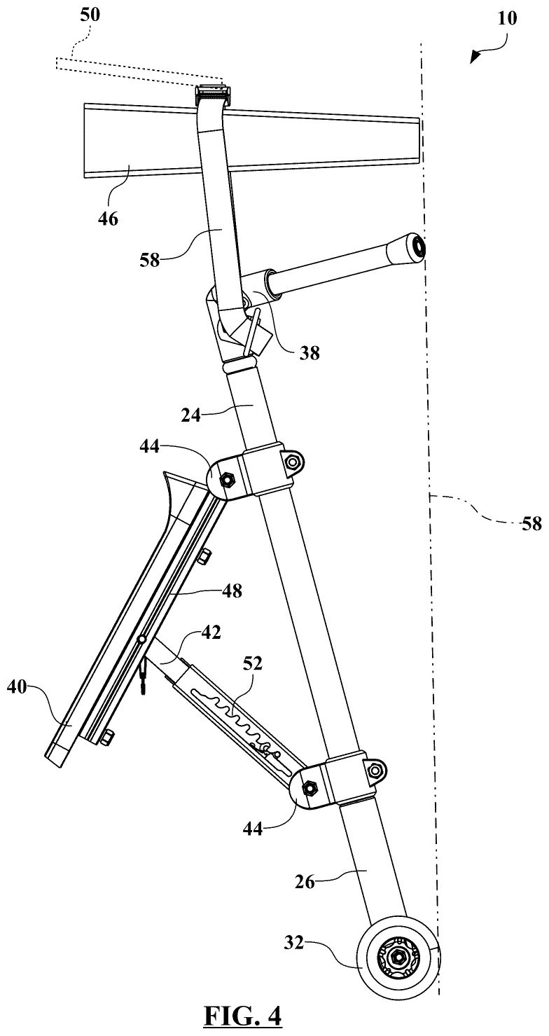

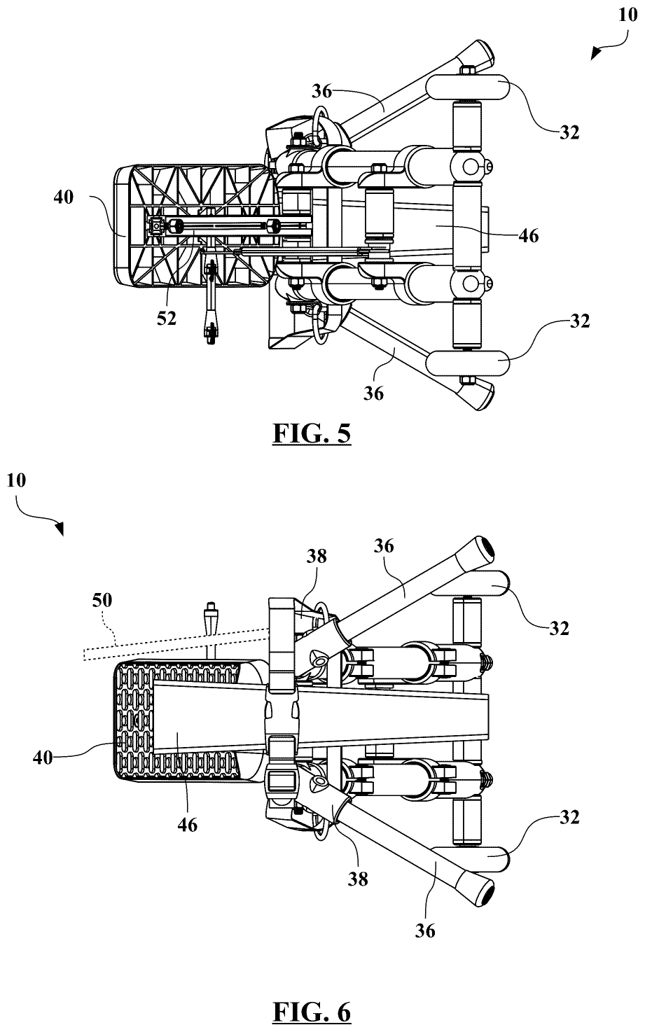

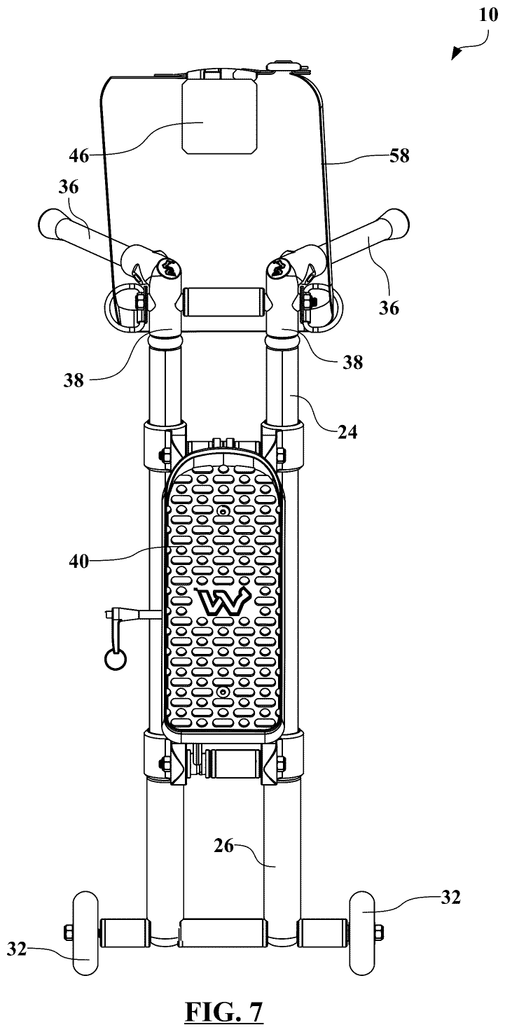

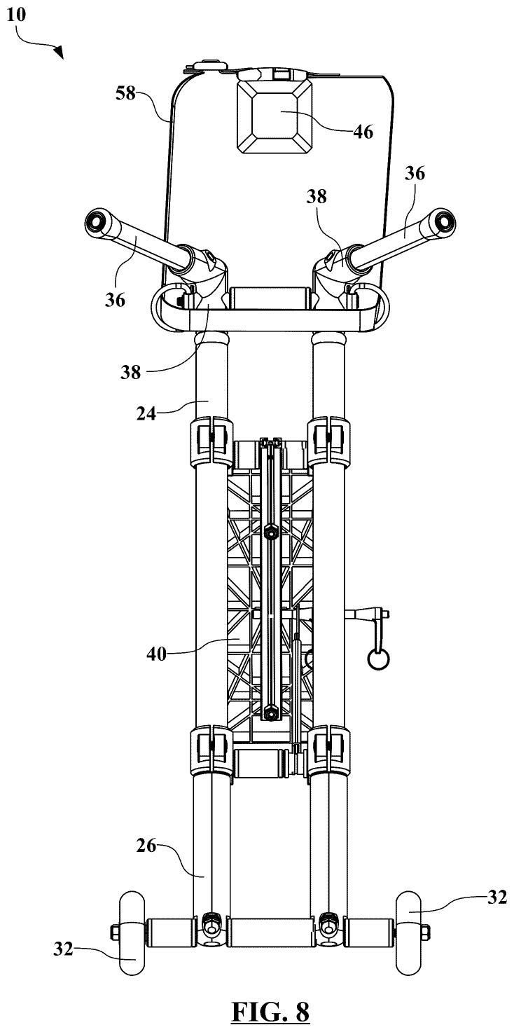

Notably, in the embodiments illustrated by the drawings, one or more wheels 32 may be in contact with a supporting surface, such as a floor 58—which is shown highly schematically in FIGS. 3 and 4—in addition to other supporting surfaces, as will be recognized by those having ordinary skill in the art.

The user's foot is positioned on a foot plate 40 which is attached to the first rod segment 24 such that in use, the first rod segment 24 is rolling and not stationary when extending and/or stretching the user's knee 30 joint, which is not shown in the figures. A plate adjuster 42 may also be used and a pivot joint 44, may join the plate adjuster 42 to the second rod segments 26 or other structures. This may generally be attached to the first rod segments 24 of the extension rods 22 and are rolled from a fully extended position towards and relative to the first rod segments 24. This may also be referred to as a limb support mechanism. Note that by changing the angle of the foot plate 40, you alter the angle of the knee 30, which allows variability of the angle of the knee 30 during manipulation.

One or more leg adjusters 38 may also be used, which are shown, generally, throughout the figures. One or more braces 46, or simply a brace 46, may be used, these are located throughout the figures. A plate mount 48 may generally hold the foot plate 40. Additionally, there may be a small rubber bumper O-ring located between the extension rods 22, the first rod segments 24, the second rod segments 26, or other components.

A retainer clip 50 may or may not be used and is shown highly schematically in FIGS. 3, 4 and 6. This may be attached or in contact with the chair, for example, by interference with the chair and/or by use of the retainer clip 50.

A footplate adjustor 52—alternatively may be referred to as a stretch indicator 52—may be attached to the plate mount 48 and/or the foot plate 40. Note that the footplate adjustor 52 is adjustable, such that it may be adjusted to the user preference. This is best shown in FIGS. 1-4. A band, or wrap 60, may be used to hold several of the components together.

Also, by rolling closer to the far end, the angle changes of the foot plate 40—i.e. the leg/knee 30 positioning is not stationary. Alternative methods and for the retainer clip 50 configurations may be used to attach the device to the chair. Additionally, there may be a strap connecting around chair/seat.

In another example embodiment further shown in the accompanying drawings, the frame assembly 20 may have two extension rods 22, where at least one of the extension rods 22 is driven by the linear actuator 28. In one example, both movement of the first rod segments 24 of both extension rods 22 is driven. In another example, movement of the first rod segments 24 of one rod is driven by linear actuator 28, and movement of the first rod segments 24 of the second rod segments 26 is passive in response to the driven movement of the first rod segments 24. Note that a quick release mechanism that will release the tension if the motor does not turn off.

The term “comprising,” and variations thereof as used herein is used synonymously with the term “including,” and variations thereof and are open, non-limiting terms. Although the terms “comprising” and “including” have been used herein to describe various embodiments, the terms “consisting essentially of” and “consisting of” can be used in place of ‘comprising’ and “including” to provide more specific embodiments and are also disclosed. As used in this disclosure and in the appended claims, the singular forms “a”, “an”, “the”, include plural referents unless the context clearly dictates otherwise.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A device for manipulating a joint of a limb of a user, comprising:
a linear actuator composed of at least two segments;
one or more first rod segments is positioned relative to the user, supported by a wheel assembly having one or more wheels, such that the first rod segments is movable relative to a support surface, including a floor;
one or more second rod segments is located relative to the user and is secured to a stabilized object, such as a chair, such that the position of the second rod segments are secure; and
a limb support mechanism is attached to the first rod segments such that when the first rod segments of the linear actuator moves, the limb support mechanism moves in a substantially parallel path as the linear actuator, and the joint of the user is manipulated.

2. The device for manipulating a joint of a limb of a user of claim 1, further comprising:
a footplate adjustor,
a foot plate, wherein the foot plate is adjustable to varying different angles via the footplate adjustor.

3. The device for manipulating a joint of a limb of a user of claim 2, wherein the limb support mechanism is one of a foot mount, a limb strap, or a limb support.

4. The device for manipulating a joint of a limb of a user of claim 3, further comprising:
a second linear actuator positioned or attached to the device to manipulate or position a second joint.

5. The device for manipulating a joint of a limb of a user of claim 4,
wherein the limb support mechanism is a foot plate for supporting a foot of a user; and
wherein the limb of the user being manipulated is one of the legs including a knee joint.

6. The device for manipulating a joint of a limb of a user of claim 5, wherein movement of the device by an electromechanical means.

7. The device for manipulating a joint of a limb of a user of claim 6, further comprising:
a frame assembly including one or more linear actuators, wherein the frame assembly is positioned at an incline from the support surface.

8. The device for manipulating a joint of a limb of a user of claim 7, wherein a leg assembly is operatively attached to the second rod segments to support the device in the use position.

9. The device for manipulating a joint of a limb of a user of claim 8, further comprising:
the first rod segments are an outer housing of a rod cylinder and the second rod segments are an inner rod of a rod cylinder.

10. The device for manipulating a joint of a limb of a user of claim 1, further comprising:
a footplate adjustor, which is selectively positioned to lock at a predetermined angle.

11. The device for manipulating a joint of a limb of a user of claim 10, further comprising:
the first rod segments are an outer housing of a rod cylinder and the second rod segments are an inner rod of a rod cylinder.

12. The device for manipulating a joint of a limb of a user of claim 11, further comprising:
a frame assembly including one or more linear actuators, wherein the frame assembly is positioned at an incline from the support surface.

13. The device for manipulating a joint of a limb of a user of claim 12, wherein a movement of the device by an electromechanical means.

14. The device for manipulating a joint of a limb of a user of claim 13, further comprising:
a foot plate, wherein the footplate adjustor adjusts the predetermined angle of the foot plate.

15. The device for manipulating a joint of a limb of a user of claim 14, wherein the user controls the linear actuators with one of a wireless remote control or a wired remote control.

16. A method for manipulating a joint of a limb of a user, comprising:
placing the device on a floor or the other supporting surface;
aligning the joint of the limb with a foot plate;
locking a footplate adjustor of the device into a predetermined position; and
actuating the device by moving the device via a foot plate.

17. The method for manipulating a joint of a limb of a user of claim 16, wherein a movement of the device is via electromechanical means.

18. The method for manipulating a joint of a limb of a user of claim 17, further comprising:
wherein the user controls one or more linear actuators with one of a wireless remote control or a wired remote control.

19. The method for manipulating a joint of a limb of a user of claim 18, further comprising:
using a foot plate; and
using a footplate adjustor, wherein the footplate adjustor adjusts an angle of the foot plate.
